(19) United States
(12) Patent Application Publication
(10) Pub. No.: US 2007/0066208 A1
(43) Pub. Date: Mar. 22, 2007

(54) Enhanced acoustic heating, ventilation and/or air-conditioning unit

(75) Inventors: Armelle Almori, Maurepas (FR); Ralph Stroehla, Coburg (DE)

Correspondence Address: Valeo Climate Control Corp.;Intellectual Property Dept, 4100 North Atlantic Boulevard, Auburn Hills, MI, 48326, US

(73) Assignee: Valeo Systemes Thermiques S.A.S., Le Mesnil Saint Denis (FR)

(21) Appl. No.: 11/519,266

(22) Filed: Sep. 12, 2006

(30) Foreign Application Priority Data
Sep. 20, 2005 (FR) 0509578

(51) Int. Cl. B60S 1/54

(52) U.S. Cl. 454/121

(57) ABSTRACT

The present invention relates to a heating, ventilation and/or air conditioning unit, particularly for a motor vehicle interior, comprising a box (1) comprising at least one canal (10, 28, 96) having at least one wall (50, 64, 90) channelling an air flow in the box (1). The wall (50, 64, 90) comprises openings (52, 66, 92), and at least one sound absorption part (54, 60, 70, 72, 74) is arranged outside the canal (10, 28, 96) in contact with the openings (52, 66, 92).

The present invention relates to heating, ventilation and/or air conditioning units. More specifically, it relates to the enhancement of the acoustics of such units.

Heating, ventilation and/or air conditioning units comprise, as a general rule, an engine blower, cold and hot heat exchangers such as evaporators, heaters/coolers and electrical heaters. They also comprise air flow distribution means inside a box. All of these components generate noise from the circulation of air in canals or via an exchanger, the rotation of the engine driving the engine blower and the movement of flaps modifying the air flow distribution in the heating, ventilation and/or air conditioning installation.

These flaps are sources of noise particularly during their movement when they come to a stop on a wall of the heating, ventilation and/or air conditioning unit, which generally causes a bang.

It has been proposed to reduce this noise pollution by adjusting the sources of noise. In this way, the flaps have been provided with elastomer lips creating a tight closure while damping closing noises. Similarly, the heat exchanger structures and environments have been modified to reduce the generation of vibrations and noise induced by the flow of the fluid in the exchangers and air via inserts promoting heat exchange.

Similarly, engine blowers have been equipped with absorbers enabling a disconnection of this subassembly from the rest of the heating, ventilation and/or air conditioning unit and thus preventing a significant propagation of vibrations generated by the rotation of the engine.

However, such arrangements would not make it possible to obtain perfect acoustic insulation of the heating, ventilation and/or air conditioning unit. The unit itself was a source of noise. It has been proposed to add sound absorption components to the structure of the box in order to increase its acoustic insulation. Such a unit is described in the German patent application DE3639138.

However, such a solution is difficult to implement and requires a complex moulding process involving several kinds of materials. In addition, it proposes replacing an entire part of the heating, ventilation and/or air conditioning unit. Such a step renders the standardisation of this part difficult.

The purpose of the present invention is to overcome the abovementioned drawbacks. To this end, the invention proposes a heating, ventilation and/or air conditioning unit, particularly for a motor vehicle interior, comprising a box comprising at least one canal having at least one wall channelling an air flow in the box. The wall of the canal comprises openings and a sound absorption part is arranged outside the canal in contact with the openings produced in the wall of the canal.

By means of the invention, it is possible to enhance the acoustics of the engine blower without increasing the overall cost. In fact, the part used to hold the acoustic material in place is from the heating, ventilation and/or air conditioning box.

In addition, according to a first alternative embodiment, the sound absorption part is arranged in a housing arranged outside the canal.

The housing comprises walls in contact with the surrounding walls of a motor vehicle interior. This housing is sealed tightly by the surrounding walls of the motor vehicle interior. According to another embodiment, the housing is closed tightly by side covers.

The sound absorption part according to the present invention is held in place by a cover sealing the canal tightly. This cover is connected to a condensate collection component of the unit. Preferentially, the cover is assembled with the box by fastening means. In an alternative embodiment, the cover is connected to the box by a film hinge.

According to another embodiment, the sound absorption part is held in place by an additional box sealing the canal tightly. This additional box is assembled with the box by fastening means.

Preferentially, the sound absorption part is a layer of foam with open pores. Alternatively, the sound absorption part is a layer of foam with closed pores.

According to another example of an embodiment, the wall comprising the openings is mounted on the box. According to another embodiment, the wall is obtained from moulding with the box.

Other advantages and characteristics of the invention will emerge on reading the following description. This description is purely illustrative and given as an example and must be read with reference to the appended figures representing:

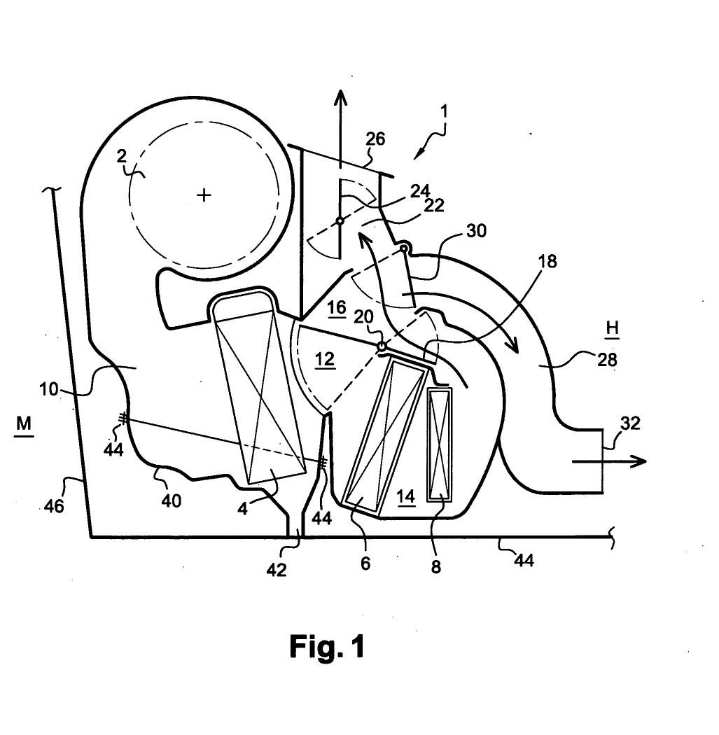

In FIG. 1, a heating, ventilation and/or air conditioning unit according to the prior art,

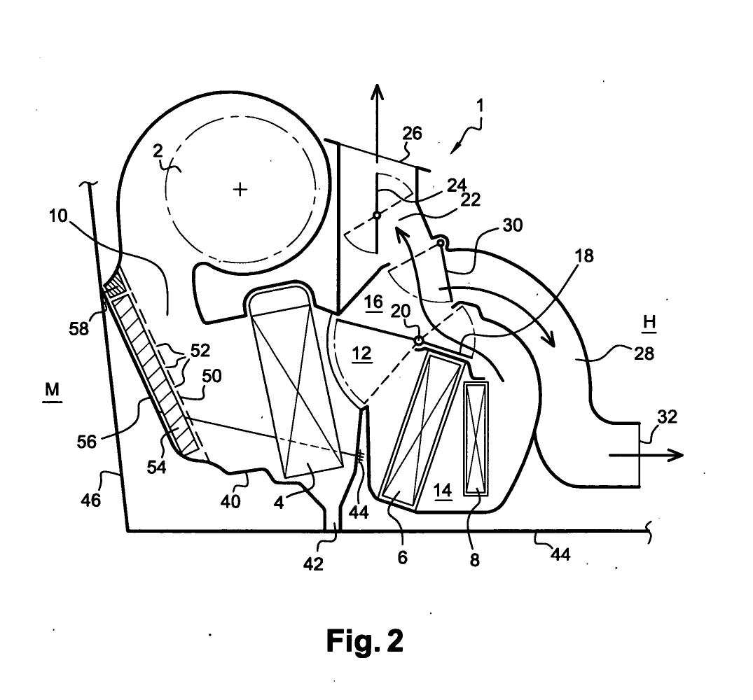

In FIG. 2, a heating, ventilation and/or air conditioning unit according to a first embodiment of the present invention,

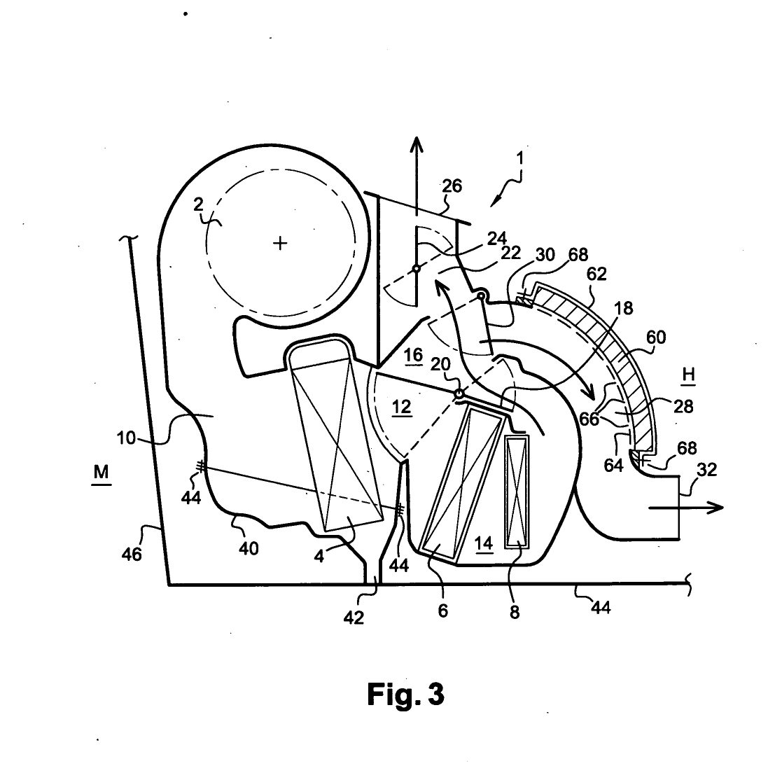

In FIG. 3, a heating, ventilation and/or air conditioning unit according to a second embodiment of the present invention, and

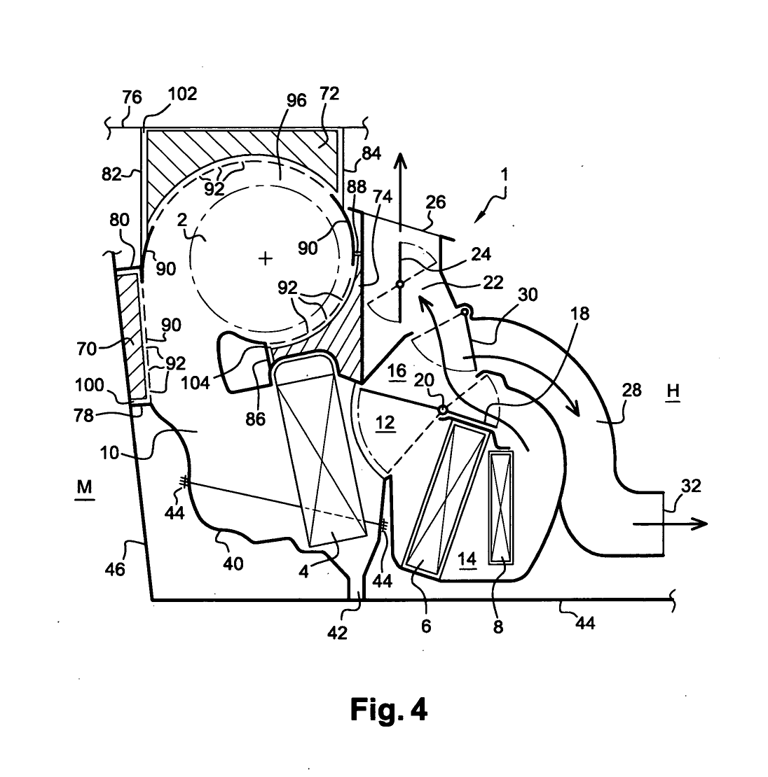

In FIG. 4, a heating, ventilation and/or air conditioning unit according to a third embodiment of the present invention.

Reference is made firstly to FIG. 1 which represents a sectional view along a vertical plane oriented in the front-rear direction of the vehicle of a heating, ventilation and/or air conditioning unit according to the prior art.

The heating, ventilation and/or air conditioning unit comprises a box 1. It comprises as main air handling components an engine blower 2, consisting of an engine and a turbine (not shown), an evaporator 4, a heater 6 and an additional heat source 8 such as a positive temperature coefficient resistor.

The box 1 may also comprise air flow filtration means such as a particle filter, a combined filter or a photocatalytic filter. These filtering components may be arranged at the air inlet (not shown) of the upstream unit, according to the direction of movement of the air, the engine blower 2 or between the engine blower 2 and the evaporator 4, upstream thereof.

The engine blower 2 is arranged on the top part and towards the front (with reference to the direction of operation of the vehicle) of the box 1 and produces an air flow which circulates in a canal 10 located at the front end of the box routing the air to the outlet of the engine blower 2, and then circulates substantially from the front to the rear via the evaporator 4, before being distributed in various trajectory components.

The trajectory components located downstream from the evaporator 4 consist of a canal 12 channelling some of the air passing through the evaporator 4 to a mixing zone 16. In parallel with the canal 12, a canal 14 channels some of the air passing through the evaporator 4 to the heater 6 and the additional source 8. More simply, the canal 12 is referred to as the cold canal and the canal 14 is referred to as the hot canal.

The distribution in the canals 12 and 14 is controlled by a flap 18. According to the example embodiment, the flap 18 is of the butterfly type. However, it is also possible to envisage using drum or flag type flaps to provide the air flow distribution function between the cold and hot canals.

A flap 18 is mounted pivoting around a transversal axis 20 extending through the box 1, so as to move between a first extreme position, represented in solid font, and a second extreme position, represented in dashed font.

In the first extreme position, the wings of the flap 18 release the inlet and the outlet of the canal 14 respectively to reach a mixing zone 16 located above the flap. The flap 18, extending over the entire width of the box, seals the direct flow from the evaporator 4 to the zone 16.

In a second extreme position, the wings of the flap 18 seal the inlet and the outlet of the canal 14 respectively. The flap 18, extending over the entire width of the box, releases the direct flow from the evaporator 4 to the zone 16 to reach a mixing zone 16.

In intermediate positions of the flap 18, the canals 12 and 14 supply, in variable proportions, the mixing zone 16 with hot air and with cold air thus making it possible to obtain a resulting air flow at the desired temperature.

From the mixing zone 16, trajectory components 22 and 28 bring the air respectively to outlets 26 and 32 connected respectively to one or more diffusers in the front zone of the car interior, to the defrosting nozzles, to a trajectory component of the foot zone of the front seat of the vehicle or the foot zone of the rear seat. Pivoting flaps 24 and 30 placed in trajectory components 22 and 32 make it possible to adjust the air flow rates reaching the corresponding outlets.

The bottom part of the heating, ventilation and/or air conditioning unit comprises a component 40 for collecting the condensates resulting from the passage of the air flow via the evaporator 4 and trickling from it. These condensates are collected by the collection component 40 and are channelled to an evacuation 42 communicating with the outside via an opening produced in the floor 44 of the vehicle. This collection component 40 also provides a support for the evaporator 4. It may also be used as a support for filtration means arranged upstream from the evaporator 4.

In order to produce a tight and cohesive assembly, the collection component 40 is assembled with the heating, ventilation and/or air conditioning unit by fastening means 44. These fastening means 44 may consist of screws, metal clips, plastic clips, etc. These fastening means 44 may be taken separately or in combination in order to assemble the collection component 40 with the heating, ventilation and/or air conditioning unit.

As a general rule, the heating, ventilation and/or air conditioning unit is arranged inside the interior H of a motor vehicle. More specifically, it is arranged above, the floor 44 of the vehicle and in the vicinity of the separating wall 46 between the engine compartment M and the interior H.

Reference will now be made to FIG. 2 which shows a sectional view along a vertical plane oriented in the front-rear direction of the vehicle of a heating, ventilation and/or air conditioning unit according to a first embodiment of the present invention.

The unit in FIG. 2 contains numerous components identical to those described with reference to FIG. 1. Consequently, they will be identified by a common reference.

The heating, ventilation and/or air conditioning unit comprises a box 1 and a collection component 40 of the condensates resulting from the passage of the air flow via the evaporator 4 and trickling down from it.

The box 1 comprises a canal 10 channelling the air at the outlet of the engine blower 2 to the evaporator 4. According to an alternative embodiment of the present invention, the external wall 50 of the canal 10 is punched by openings 52 enabling the air to flow from the canal 10 to the outside of the canal via the external wall 50.

The openings 52 may be formed using a grid, mesh or circular holes produced in the external wall 50 of the canal 10 thus creating a ventilated structure. However, these openings 52 may be obtained by any other arrangement creating spaces in a surface such as the external wall 50.

It can also be envisaged that the ventilated structure may be made on a mounted part which is assembled in the heating, ventilation and/or air conditioning unit to replace or substitute the solid external wall of the unit as described in FIG. 1.

The external wall 50 comprising openings 52 cooperates with a sound absorption part 54 housed outside the canal 10 and attached to the outer wall 50.

The part 54 provides a sound insulation lining of the canal 10 by eliminating or limiting the propagation of the noise to the outside of the box 1.

The sound absorption part 54 is held in position against the external wall 50 of the box 1 by a cover 56 inserting the part 54. The cover 56 is assembled with the box 1 so as to ensure tightness of the canal 10. In this way, the air moved by the engine blower 2 is channelled to the evaporator 4 without the openings 52 produced in the external wall 50 forming leaks.

According to the present invention, the cover 56 is connected with the collection component 40. It creates an extension of this component 40.

The collection component 40 is generally a volume form. It represents a collector serving as a tray collecting the condensates. The cover 56 may also be a volume form. In this configuration, it represents a complete part of the box 1. However, it may be envisaged that the cover 56 is a surface sealing an opening made in the box 1.

Irrespective of the configurations envisaged for the cover 56, it is an integral part of the collection component 40. In this way, during the assembling of the heating, ventilation and/or air conditioning unit, the cover 56 will be mounted at the same time as the collection component 40. Once assembled, the sound absorption part 54 is held inside the box 1 and is protected from the outside by the cover 56. This prevents any risk of damage of the sound absorption part 54 during the assembly of the heating, ventilation and/or air conditioning unit in the vehicle interior H.

In addition, the sound absorption part 54, the cover 56 and the box 1 are separate parts which are assembled together. The assembly and the production of the various components are simple as the parts of the box 1 and the collection component 40 with the cover 56 are obtained by moulding and are made of plastic.

In order to carry out the assembly on the box of the assembly consisting of the collection component 40 and the cover 56, fastening means to position and hold the assembly in place with the box 1 are provided.

It is possible to use the fastening means 44 provided for the assembly of the collection component 40 on the box 1. It is also possible to use fastening components 58, specifically for the cover 56. These fastening means 58, as for the fastening means 44, may consist of screws, metal clips, plastic clips, etc. These fastening means 58 may be taken separately or in combination in order to assemble the assembly comprising the collection component 40 and the cover 56 with the heating, ventilation and/or air conditioning component.

In the example shown, the sound absorption part 54 is a layer of polyurethane foam with open pores. Preferentially, it is impregnated with a vinylidene copolymer.

In order to protect the sound absorption part 54 against the penetration of water or other agents, it is planned to provide the part 54 with a water-tight protective film, attached to the layer of foam.

According to another embodiment, the sound absorption part 54 is a layer of foam comprising closed pores. In this way, the acoustic performances are preserved irrespective of the environment.

FIG. 3 shows a sectional view along a vertical plane oriented in the front-rear direction of the vehicle of a heating, ventilation and/or air conditioning unit according to a second embodiment of the present invention.

The unit in FIG. 2 contains numerous components identical to those described with reference to FIGS. 1 and 2. Consequently, they will be identified by a common reference.

The heating, ventilation and/or air conditioning unit differs from the example described in FIG. 2 by the location of the sound absorption part.

In fact, depending on the sound insulation requirements of a specific part of the heating, ventilation and/or air conditioning unit, it is possible to introduce a sound absorption part in the vicinity of the zone for which the level of noise is to be reduced.

In this way, the example described in FIG. 3 comprises a sound absorption part 60 cooperating with the external wall 64 of the canal 28 comprising openings 66.

The sound absorption part 60 is housed outside the canal 28 and is attached to the external wall 64.

As in the canal 10 described in the example in FIG. 2, the external wall 64 of the canal 28 is punched with openings 66 enabling air to flow from the canal 28 to the outside of the canal via the external wall 64.

The openings 66 may be formed using methods similar to those used to obtain the openings 52.

Similarly, it can also be envisaged for the external wall 64 to be made on a mounted part which is assembled in the heating, ventilation and/or air conditioning unit to replace or substitute the solid external wall of the unit as described in FIG. 1.

The part 60 provides a sound insulation lining of the canal 28 by eliminating or limiting the propagation of noise to the outside of the box 1.

The sound absorption part 60 is held in position against the external wall 64 of the box 1 by an additional box 62 lining the part 60. The additional box 62 is assembled with the box 1 so as to ensure tightness of the canal 28. In this way, the air flow from the mixing zone 16 is channelled to the outlet 32 without the openings 66 made in the external wall 64 forming leaks.

In order to carry out the assembly on the box 1 of the additional box 62, fastening means ensuring the positioning and support thereof are provided.

The fastening means are similar to those described above. It is possible to use the fastening means 44 provided for the assembling of the collection component 40 on the box 1. It is also possible to use fastening components 68, specifically for the additional box 62. These fastening means 68, as for the fastening means 44 and 58, may consist of screws, metal clips, plastic clips, etc. These fastening means 68 may be taken separately or in combination in order to assemble the additional box 62 with the heating, ventilation and/or air conditioning unit.

In order to fulfil its sound absorption function fully, the sound absorption part 60 is a layer of polyurethane foam comprising open pores. Preferentially, it is impregnated with a vinylidene copolymer.

The sound absorption part 60 is similar to the sound absorption part 54 and is made of the same materials. It has the same properties and characteristics.

FIG. 4 shows a sectional view along a vertical plane oriented in the front-rear direction of the vehicle of a heating, ventilation and/or air conditioning unit according to a third embodiment of the present invention.

The unit in FIG. 4 contains numerous components identical to those described with reference to FIGS. 1 to 3. Consequently, they will be identified by a common reference.

The heating, ventilation and/or air conditioning unit differs from the example described in FIGS. 1 and 2 by the arrangement of the sound absorption part and the method to hold same.

In fact, the layouts and arrangements of the heating, ventilation and/or air conditioning unit may make it difficult to produce additional boxes or covers protecting the sound absorption part.

As described in the example in FIG. 4, the heating, ventilation and/or air conditioning unit comprises sound absorption parts 70, 72 and 74 which cooperate with the wall 90 of the blower housing 96 surrounding the engine blower 2. The wall 90 comprises openings 92. The sound absorption parts 70, 72 and 74 are housed outside the blower housing 96 and are attached to the wall 90 of the turbine.

The openings 92 are similar to the openings 52 and 66 described above. They are obtained and arranged in an identical manner to those of the openings 52 and 66.

The parts 71, 72 and 74 provide a sound insulation lining of the blower housing 96 of the engine blower 2 by eliminating or limiting the propagation of noise to the outside of the box 1.

The parts 71, 72 and 74 are arranged in the immediate vicinity of a main source of noise in the heating, ventilation and/or air conditioning unit. Therefore, the rendition of such an arrangement is enhanced as it is carried out as close as possible to the causes to be controlled.

The sound absorption parts 71, 72 and 74 are mounted in the housings 100, 102 and 104 comprising walls 78, 80, 82, 84, 86 and 88. The housings 100, 102 and 104 are not closed. They serve as collectors for the sound absorption parts 71, 72 and 74.

The sound absorption parts 70, 72 and 74 are held in place retrospectively during the assembling of the heating, ventilation and/or air conditioning unit in the vehicle interior H. In fact, during the positioning of the heating, ventilation and/or air conditioning unit, the housings 100 and 102 rest on the surrounding walls 46 and 76. The wall 46 is the separating wall between the engine compartment M and the car interior H. The wall 76 consists of the internal wall of the dashboard of the vehicle interior H.

In this way, when the heating, ventilation and/or air conditioning unit is in position in the car interior H, the housings 100 and 102 are closed and the sound absorption parts 70 and 72 are held in position. Such an arrangement ensures tight assembling. In this way, the air flow generated by the engine blower 2 is channelled to the canal 10 without the openings 92 made in the wall 90 of the blower housing 96 forming leaks.

Alternatively, the sound absorption part 74 is inserted into the housing 86, for example by sliding the sound absorption part 74 in the space separating the outside of the blower housing 96 of the canal 22 leading to the outlet 26. In such a configuration, it is necessary to provide side covers (not shown) to seal the opening(s) via which the sound absorption part 74 was inserted into the housing 86. These additional covers are used to ensure the tightness of the heating, ventilation and/or air conditioning unit.

Also in this alternative embodiment, the sound absorption parts 70, 72 and 74 are layers of polyurethane foam comprising open pores. Preferentially, they are impregnated with a vinylidene copolymer.

These sound absorption parts are similar to the sound absorption parts 54 and 60 and are made of the same materials. They have the same properties and characteristics.

The various embodiments described above differ structurally from each other. However, it may be envisaged to use them separately or in combination with each other in order to obtain the desired acoustic performances.

In addition, in some types of units, the condensate collection component is integrated directly in the heating, ventilation and/or air conditioning unit. In such architectures, the housing surrounding the sound absorption part is obtained directly from moulding and is an integral part of the box of the heating, ventilation and/or air conditioning unit. In this example of an embodiment, the cover sealing the housing is also obtained by moulding. It is then connected to the box of the heating, ventilation and/or air conditioning unit via a film hinge.

In addition, the examples of embodiments described above integrate sound absorption parts consisting of layers of foam, such as polyurethane which comprise open pores.

However, these layers of open pore foam may be replaced by closed pore foam. In the same way, the present invention also covers sound insulation materials with similar or better performances than the foams described above.

The present invention has a specific application in the heating, ventilation and/or air conditioning installation of motor vehicles as described above.

Naturally, the invention is not limited to the embodiments described above and given only as examples and covers other alternative embodiments that may be envisaged within the scope of the claims by those skilled in the art.

1. Heating, ventilation and/or air conditioning unit, particularly for a motor vehicle interior, comprising a box (1) comprising at least one canal (10, 28, 96) having at least one wall (50, 64, 90) channelling an air flow in the box (1),
characterised in that the wall (50, 64, 90) comprises openings (52, 66, 92) and in that at least one sound absorption part (54, 60, 70, 72, 74) is arranged outside the canal (10, 28, 96) in contact with the openings (52, 66, 92).

2. Heating, ventilation and/or air conditioning unit according to claim 1, wherein the sound absorption part (70, 72, 74) is arranged in a housing (100, 102, 104) arranged outside the canal (10, 28, 96).

3. Heating, ventilation and/or air conditioning unit according to claim 2, wherein the housing (100, 102, 104) comprises walls (78, 80, 82, 84, 86, 88) in contact with the surrounding walls (46, 76) of a car interior H.

4. Heating, ventilation and/or air conditioning unit according to claim 3, wherein the housing (100, 102) is sealed tightly by the surrounding walls (46, 76) of the car interior H.

5. Heating, ventilation and/or air conditioning unit according to claim 3, wherein the housing (104) is sealed tightly by side covers.

6. Heating, ventilation and/or air conditioning unit according to any of claims 1 to 5, wherein the sound absorption part (54) is held in place by a cover (56) sealing the canal (10) tightly.

7. Heating, ventilation and/or air conditioning unit according to claim 6, wherein the cover (56) is connected to a collection component (40) of the condensates from the unit.

8. Heating, ventilation and/or air conditioning unit according to claim 6 or 7, wherein the cover (56) is assembled with the box (1) by fastening means (58).

9. Heating, ventilation and/or air conditioning unit according to any of claims 6 to 8, wherein the cover (56) is connected to the box (1) by a film hinge.

10. Heating, ventilation and/or air conditioning unit according to any of claims 1 to 9, wherein the sound absorption part (60) is held in place by an additional box (62) sealing the canal (28) tightly.

11. Heating, ventilation and/or air conditioning unit according to claim 10, wherein the additional box (62) is assembled with the box (1) by fastening means (68).

12. Heating, ventilation and/or air conditioning unit according to any of the above claims, wherein the sound absorption part (54, 60, 70, 72, 74) is a layer of foam with open pores.

13. Heating, ventilation and/or air conditioning unit according to any of claims 1 to 11, wherein the sound absorption part (54, 60, 70, 72, 74) is a layer of foam with closed pores.

14. Heating, ventilation and/or air conditioning unit according to any of the above claims, wherein the wall (50, 64, 90) is mounted on the box (1).

15. Heating, ventilation and/or air conditioning unit according to any of claims 1 to 13, wherein the wall (50, 64, 90) is obtained from moulding with the box (1).
